(19) United States
(12) Patent Application Publication
(10) Pub. No.: US 2026/0179113 A1
(43) Pub. Date: Jun. 25, 2026

(54) INTELLIGENT PARKING SERVICES AND SYSTEMS AND METHODS FOR MANAGING THE SAME

(71) Applicant: Toyota Jidosha Kabushiki Kaisha, Toyota-shi Aichi-ken (JP)

(72) Inventor: Alexander Granieri, Mountain View, CA (US)

(73) Assignee: Toyota Jidosha Kabushiki Kaisha, Toyota-shi Aichi-ken (JP)

(21) Appl. No.: 18/988,229

(22) Filed: Dec. 19, 2024

(51) Int. Cl. G06Q 30/0207; G08G 1/14

(52) U.S. Cl. CPC G06Q 30/0207; G08G 1/143; G08G 1/146

(57) ABSTRACT

A system, method, and participating vehicle for managing parking availability in an area are disclosed. The system includes a parking system configured to receive sensor data transmitted by one or more vehicles which relate to parking availability in an area. With this information, the parking system can, in real-time, provide parking availability information to incoming vehicles in order to alleviate stress and uncertainty with respect to parking the vehicle. The parking system may also provide incentives to occupants to vacate parking spots if a vehicle has been parked in a given spot for a predetermined amount of time and/or provide incentives to occupants of incoming vehicles to park in less desirable parking spots. The parking system may also incorporate information and/or notifications from point of sale systems or the like to improve predictions regarding when a spot will likely be vacated.

### TECHNICAL FIELD

Embodiments described herein generally relate to parking assistance systems for manually and/or autonomously driven vehicles as well as networks involving the same.

### BACKGROUND

Integrating parking assistance into traditional navigation or trip planning systems is often problematic because, unlike real-time traffic data, real-time parking information is rarely available. Even if one is able to identify on a map where parking areas, such as parking garages, parking lots, on-street parking, and the like, may be located, there is often no information at hand with respect to whether those parking areas actually have spots available in which a vehicle may be parked until one reaches the parking area. It may also be unclear what costs may be involved when parking in a given parking area and/or whether time-dependent pricing may be involved. As a result, navigation systems typically do not address the parking portion of a trip, creating great uncertainty and stress for drivers and passengers alike.

This lack of transparency also affects the owners/operators of parking facilities, as there are few options available by which these owners/operators might increase the utilization of their facilities. If parking spots have recently become available or will soon become available, the owners/operators of these facilities have no way to communicate this information to incoming drivers and/or to attract drivers to the parking facility.

Thus, new configurations, systems, and methods may be desired to increase the transparency regarding parking availability, thereby alleviating stress for drivers and increasing utilization for owners/operators of parking facilities.

### SUMMARY

In one embodiment, a system for managing parking availability comprising a parking system which includes at least one processor and which is configured to identify whether a vehicle has been parked at a certain parking location for a predetermined amount of time; transmit a message to an occupant of the vehicle, the message including an incentive for the occupant of the vehicle to remove the vehicle from the parking location; and receive, from the occupant, a response to the message, the response including an indication as to when the occupant will remove the vehicle from the parking location.

In another embodiment, a method for managing parking availability, comprising steps of identifying whether a vehicle has been parked at a parking location for a predetermined amount of time, transmitting a message to an occupant of the vehicle, the message including an incentive for the occupant of the vehicle to remove the vehicle from the parking location, receiving, from the occupant, a response to the message which includes an indication as to when the occupant will remove the vehicle from the parking location, and transmitting, to a subsequent vehicle, information regarding parking availability at the parking location derived from the indication.

In another embodiment, a vehicle which interacts with a parking system, the vehicle comprising at least one sensor, a network interface, and wherein the vehicle is configured to use the at least one sensor to scan an environment around the vehicle to ascertain parking-related information and/or parking availability; transmit the sensor data to the parking system; receive, from the parking system, a message including an incentive for an occupant of the vehicle to remove the vehicle from a parking location currently occupied by the vehicle; and transmit, to the parking system, a response to the message, which indicates when the occupant will remove the vehicle from the parking location.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a block diagram depicting an exemplary system including a parking system according to one or more embodiments described and/or illustrated herein;

FIG. 2 schematically depicts an exemplary parking management scenario according to one or more embodiments described and/or illustrated herein; and

FIG. 3 depicts an exemplary flow chart relating to a method for managing parking availability according to one or more embodiments described and/or illustrated herein.

### DETAILED DESCRIPTION

Embodiments of the disclosure herein provide for an improved parking system which leverages network-based solutions to, in real-time: identify parking availability, provide incentives to increase parking availability, and/or convey information relating to parking availability to vehicles.

This overall scheme is achieved, in part, by using one or more sensors provided on-board a vehicle to ascertain the availability of parking as sensed by the vehicle, by transmitting information relating to parking availability to a server, and by making the parking availability information accessible to other vehicles by way of the server. The information made available by the server may then be used in the various embodiments to assist in trip planning and/or navigation, improving trip travel times, improving walking times, and/or improving parking spot utilization, and the like.

Embodiments disclosed herein may, additionally or alternatively, consider information such as parking metadata (e.g., how long a vehicle has been parked in a given spot, what the typical parking time for a spot is), information incident on parking usage (e.g., point of sale information/interactions, event start/end times, user searches on a mobile device for nearby activities/locations), trip-based information (e.g., navigation to/from the parking facility and/or a location near to the parking facility), and the like to assist in the prediction and management of parking availability. Embodiments disclosed herein may, additionally or alternatively, include actively influencing the availability of parking spaces, such as by, e.g., offering incentives to an occupant of currently parked vehicles to move their vehicle or to park their vehicle at another location.

The term “occupant,” as used herein, may refer to any of drivers, passengers, persons (such as fleet managers, coordinators, dispatchers, and the like), and/or autonomous vehicle control stacks which are associated with a given vehicle. Except where explicitly indicated otherwise, “occupant” is not to be limited with respect to whether said person is currently occupying a vehicle (e.g., a passenger who exits a vehicle to go see a movie is still considered an occupant of the vehicle while they are sitting in the theater and the vehicle is parked outside). In situations concerning fleet vehicles, autonomous vehicles, or similar, “occupant” may simultaneously refer to both a driver of a vehicle and a dispatcher. In other scenarios, “occupant” may simultaneously refer to both a passenger and an autonomous vehicle control stack. In other words, messages, responses, messaging, notifications, and the like may be sent to/from/between all entities embodying “occupant” as may be relevant to the presented scenario.

The term “vehicle,” as used herein, may refer to any car, truck, motorcycle, van, scooter, or the like, without limit, used in the course of personal, recreational, or commercial transportation. The vehicle may be manually driven by an occupant, semi-autonomously driven, or fully autonomous, at any level of automation, such as that defined by the Society of Automotive Engineers (SAE) J31016 standard levels 0 through 5.

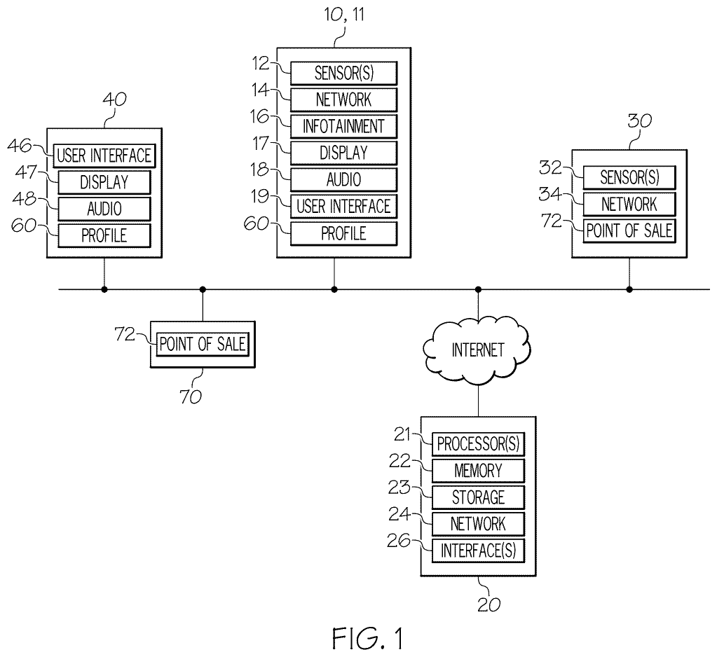

Turning now to FIG. 1, vehicle 10 may be provided with one or more sensors 12 for detecting the environment around the vehicle. Sensors 12 may include cameras or visual light sensors, infrared/ultraviolet cameras/sensors, radar emitters/detectors, ultrasonic emitters/detectors, LiDAR scanners, time-of-flight scanners/detectors, and any other similar or comparable scanner or detector which is capable of taking measurements of an environment at a distance. The one or more sensors 12 may also include devices such as GPS sensors or sensors of other satellite-position based technologies, clocks/timers, and the like necessary to facilitate operation of the vehicle 10 and/or other sensors 12.

Each vehicle 10 may also be provided with one or more network interfaces 14, such as cellular data interfaces (e.g., 3G, 4G, 5G, LTE, GSM, without limitation), satellite uplinks and/or modems, WiFi, Bluetooth, ZigBee, Z-wave, RFID, and the like by which the vehicle may communicate, directly or indirectly, with a parking system 20. The vehicle 10 may further be provided with any processors, memory units, computer storage units, user interfaces, application-specific integrated circuits (ASICs), and the like necessary to establish communication with the parking system 20, to facilitate user interaction with systems of the vehicle 10 and/or the parking system 20, to operate the one or more sensors 12 provided on-board the vehicle, and/or to conduct any intermediate operations in facilitation of the same.

Each vehicle 10 may also be provided with an infotainment system 16 through which any of a radio or sound system, navigational system, climate control system, and the like may be manipulated by an occupant of the vehicle. Each vehicle 10 may also be provided with, as part of or in addition to those elements of the infotainment system 16, display devices 17, audio devices 18 and/or user interfaces 19 for communicating with and/or exchanging inputs with the occupant. For example, display devices 17 may include any of dashboard displays, infotainment displays, heads-up displays, projected displays, screens, and the like without limitation. Audio devices 18 may include any of speakers, microphones, audio out ports (such as a headphone jack), Bluetooth connected audio, and the like without limitation. User interfaces 19 may include any of touchscreens, keyboards, buttons, dials, levers, microphones, and the like without limitation.

Infotainment system 16 may be operatively coupled to, in connection with, or in communication with any of the processors, memory, storage interfaces, etc. discussed above and/or may include or correspond to the processors/memory, storage interfaces, etc. discussed above.

The parking system 20 may be embodied as a server, a networked and/or Internet-accessible database, a cloud-computing platform, a website, a repository, an app-delivery platform, or any other suitable computing device remote to the vehicles 10 and/or infrastructure systems 30. However, it is contemplated that parking system 20 may also be part of a given infrastructure system 30 or vice versa. Parking system 20 may include any processors 21, memory units 22, computer storage units 23, user interfaces 26 (such as displays, audio systems, user input devices, and the like), network interfaces 24, ASICs, and the like to carry out functions relating to normal operation and/or to carry out and/or facilitate those methods and procedures set forth herein further to those descriptions set forth above.

One or more infrastructure systems 30 may be provided, such as parking meters, parking lot or parking facility access control systems, and/or parking management systems. Each infrastructure system 30 may likewise be provided with one or more sensors 32 further to the descriptions set forth above, one or more network interfaces 34 further to the descriptions set forth above, and any processors, memory units, computer storage units, user interfaces, displays, audio systems, ASICs, and the like to carry out functions relating to normal operation and/or to carry out and/or facilitate those methods and procedures set forth herein further to those descriptions set forth above.

Occupants of the vehicles may have mobile devices 40, such as smartphones, feature phones, tablets, smartwatches, palm devices, and/or the like, which may be operatively coupled to, in connection with, or in communication with any of the systems of the one or more vehicles 10, parking system 20, and/or infrastructure system 30. Similar to the above, mobile devices 40 may include: user interfaces 46 such as touch screens and/or buttons; display screens 47; audio systems 48 such as speakers, audio out ports, and/or Bluetooth connected audio; and the like which permit the occupants of the vehicles to interact with the mobile devices 40 and/or permit the mobile devices 40 to communicate or otherwise provide information to the occupants of the vehicles. In those embodiments in which an occupant is an autonomous vehicle stack, mobile devices 40 may be embodied by the relevant computer hardware associated with the autonomous vehicle.

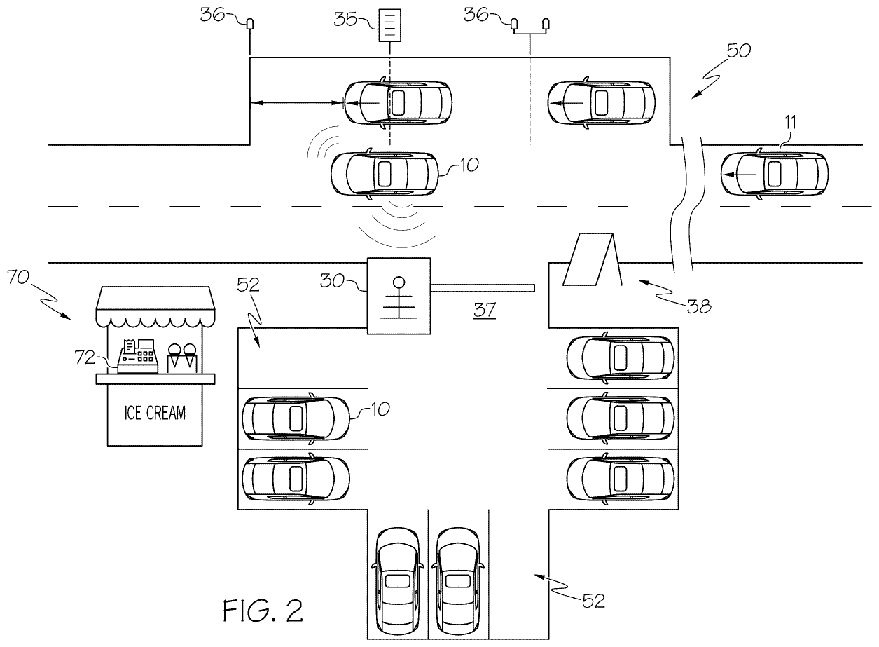

Referring now to FIGS. 1-2, as one or more of the vehicles 10 drive through an area 50, the sensors 12 of the vehicles are used to scan the environment of the area to detect available parking spots 52.

Detection of available parking spots 52 may be achieved through the collection of dimensional data, depth data, depth maps, and the like from which can be identified parameters such as how wide a shoulder or a parking lane of the road is, whether cars are currently parked on that shoulder, what the distance is between cars parked on the shoulder, the presence/dimensions of any curbs, drop-offs, obstructions, driveways, sidewalks, and the like. Detection may also include, such as when driving through a parking lot or parking garage, collection of dimensional data regarding the size of parking spots, distances between cars, whether cars are parked in a given spot, whether there is enough room for another car in a given spot (e.g., due to another car not parking within established lines).

Detection of available parking spots may be achieved visually, such as with a camera, from which the dimensional data/etc. discussed above might be derived. Additionally or alternatively, visual detection of available parking spaces may include the imaging and subsequent detection of indicators like parking-related signage 35, parking meters 36, parking lot entryways 37, parking lot display signage 38 (e.g., “lot full” signs, “event parking only” signs, “monthly parking only” signs, and/or signs that display how many spots remain in a given lot/garage and/or on a given level of said lot/garage), and the like.

Detection of available parking spots may be achieved by the transmission of signals from one or more infrastructure systems 30 to the vehicle 10, such as by parking meters broadcasting a signal that time has expired, a signal indicating the time remaining for a given parking session, a signal that no vehicle is currently parked in a spot, a signal directly indicating pricing information, and/or a signal indicating a parking zone, spot number or the like which facilitates the looking up of pricing information for a spot. Likewise an infrastructure system 30 for a parking lot/garage may broadcast information receivable by the vehicles relating to how many spots are available, pricing, and the like.

The parking system 20 may receive and make available the data transmitted to the parking system 20 by vehicles 10 and/or infrastructure systems 30 as-is. Additionally/alternatively, the parking system 20 may further process the data received from the vehicles 10 and/or infrastructure systems to provide more in-depth parking availability information. Additionally/alternatively, the parking system 20 may have access to or otherwise be provided with additional data relating to parking availability that may or may not originate from any of the vehicles 10 or infrastructure systems 30. Examples of this additional data may include maps of an area, such as city/state maps, roadway maps, topographical maps, mapping information relating to addresses, names of properties/stores/establishments, and the like. This additional data may be combined with, supplement, or otherwise be used with the data received from vehicles 10 and/or infrastructure systems 30 as needed to convey relevant information to the vehicles 10 and any subsequent vehicles 11.

For example, a given infrastructure system 30 for a parking garage may only provide to the parking system 20 the number of available parking spots and a typical hourly/daily rate for parking. With the addition of sensor data provided by vehicles 10 driving past/through the garage, the parking system 20 may be able to provide to a subsequent vehicle 11: information describing where the available spots are located (e.g., of twenty-five available spots, five are available on level three and twenty are available on level four); a detailed map of the interior of the garage, including markers for elevator and/or stair access; indications that parking spots are only available at special event pricing instead of typical hourly/daily rates; and the like.

As another example, a given infrastructure system 30 for a parking meter may be reporting to the parking system 20 that a spot is occupied, but one or more vehicles 10 passing by the spot corresponding to the meter may identify that the spot is open or otherwise available. The one or more vehicles may optionally further detect and report to the parking system 20 that there is no signage modifying typical parking times/availability. As a result, the parking system 20 may discern that the parking meter is malfunctioning by incorrectly reporting the spot as occupied, and thus the parking system 20 may account for this malfunction and indicate to subsequent vehicles 11 the availability of the meter.

Data collected by the sensors 12, 32 may readily provide information regarding parking availability or may be processed by any number of computational models, algorithms, artificial intelligence models, machine learning models, neural network models, and the like to ascertain parking availability. This processing may occur on-board the vehicles 10, at the infrastructure systems 30, and/or the raw sensor data may be transmitted to any of the parking system 20 and/or infrastructure systems 30 for processing.

As a subsequent vehicle 11 is navigating to a destination, the subsequent vehicle may regularly query the parking system 20 for information regarding parking availability at the destination. The rate at which these queries are transmitted to the parking system 20 may be constant or may increase the closer the subsequent vehicle 11 is to its destination. Likewise, the parking availability information transmitted to the subsequent vehicle 11 by the server may be constant or may increase in resolution the closer the subsequent vehicle 11 is to its destination.

For example, the server may only provide to the subsequent vehicle 11 a heat map of possible parking availability while the subsequent vehicle 11 is further away from its destination. However, as the subsequent vehicle 11 draws nearer to the destination, the parking system 20 may begin transmitting to the subsequent vehicle 11 details regarding specific parking spots which are available for the subsequent vehicle 11 to park in.

A user profile 60 associated with the subsequent vehicle 11 may include occupant preferences regarding parking spaces, such as: pricing preferences, preferences for spot/facility type (e.g., open lots, garages, valet parking, on-street parking, covered/uncovered), preferences regarding distances to a planned destination, and/or relationships correlating/linking/among the same (e.g., higher prices are acceptable closer to a destination, but not farther from the destination). When querying the parking system 20 for parking availability, the subsequent vehicle 11 may include with this query the user profile 60 so that the parking system 20 may filter parking availability accordingly. Additionally/alternatively, the user profile 60 remains on-board the subsequent vehicle 11 and the subsequent vehicle 11 filters the parking availability information received from the parking system 20 according to the user profile 60 before displaying the information to the occupant.

Even if a parking spot is not currently available, the parking system 20 may take into account the time remaining until the subsequent vehicle 11 reaches its destination in order to ascertain or otherwise predict what spots will become available by the time the subsequent vehicle 11 reaches its destination and requires a parking spot.

For example, if a given parking spot is associated with a two-hour parking limit, the parking system 20 is aware that a vehicle 10 has been parked in the spot for one hour, and the subsequent vehicle 11 is one or more hours away from its destination, the server may flag the parking spot as available to the subsequent vehicle 11. At the same time, if an additional subsequent vehicle is only fifteen minutes away from that parking spot associated with the two hour-hour limit, the spot may be flagged as unavailable to the additional subsequent vehicle.

In another example, if an infrastructure system 30 such as a parking meter is reporting that only thirty minutes remain on the meter, the parking system 20 may transmit to any subsequent vehicles 11 that are more than thirty minutes away an indication that the spot will be available. If, however, more money is inserted into the meter, thereby extending the time for another hour, the server may update the indications of availability accordingly to the subsequent vehicles 11 based on travel times.

In another example, a corresponding infrastructure system 30 and/or the parking system 20 may, based on historical data, user-inputted data, event data (e.g., the duration of a concert or show), or the like establish an average parking time or an expected parking time for a given spot. When considering this average/expected parking time in addition to the amount of time a vehicle 10 has already been parked in a spot, the parking system 20 may transmit to the subsequent vehicle 11 parking availability information indicating that the spot will be available if the remaining travel time for the subsequent vehicle 11 is greater than the remaining average/expected parking time left for the vehicle 10.

The parking system 20 may further consider information incident on parking times to ascertain parking availability. For example, when a vehicle 10 is parked in a parking lot or spot nearby to an establishment 70, such as a store, restaurant, or the like, the parking system 20 may receive information from the establishment 70 that a credit card of an occupant of the vehicle 10 has been swiped/processed at a point of sale system 72, such as a register, kiosk, tablet, card reader, or the like, and thus the server may anticipate that the vehicle 10 may be departing soon. The parking system 20 may predict that the vehicle 10 will depart a predetermined amount of time, such as five, ten, or fifteen minutes, after the credit card is swiped/processed.

Additionally/alternatively, the parking system 20 may, as above, utilize historical data, user-inputted data, event data, and the like to ascertain an average or expected time for the vehicle to depart after the credit card is swiped/processed.

Similarly, an infrastructure system 30 that detects that an occupant is currently paying for their parking at a kiosk, such as a pay-before-you-go type kiosk typically found in parking garages, may report the transaction to the parking system 20 and determine that the vehicle 10 associated with the credit card used and/or with the parking ticket scanned, whether recorded directly by the infrastructure system 30 or correlated with a time of entry or the like by the infrastructure system 30 or parking system 20, will be departing within a certain amount of time, as above.

In a similar manner, an occupant may search on their mobile device 40 for a nearby coffee shop, ice cream stand, shopping mall, or the like after finishing an initial stop, and these searches may be reported to the parking system 20 which, in turn, may determine that the occupant's vehicle 10 may remain parked in a spot for a longer duration and/or longer than an expected/average duration further to the above.

Likewise, transactions reported to the parking system 20 by establishments may increase and/or otherwise influence the expected duration, such as if the occupant of the vehicle 10 opens a tab at a bar, purchases movie tickets, or engages in any transaction that might suggest a longer parking duration.

In these ways, by improving the ability to predict or anticipate parking availability for a given spot/facility by determining/estimating if/when a vehicle 10 will depart, parking recommendations made by the parking system 20 to the subsequent vehicle 11 can be improved.

Additionally/alternatively, the parking system 20 may query the occupant of the vehicle 10 more directly, such as through the occupant's mobile device 40 or through an infotainment system or other interface of the vehicle 10, in order to ascertain upcoming parking availability. The parking system 20 may provide the occupant with a notification, such as a notice indicating that the parking time for a spot has expired, that the parking time will soon expire, or that the occupant has exceeded an average/expected parking time for the spot. The occupant may then respond to the parking system 20 and indicate if, whether, and/or when the occupant expects or intends to vacate the parking spot. The occupant may respond to the parking system through their mobile device 40, an infotainment system of the vehicle 10, or the like.

Additionally/alternatively, the parking system 20 may offer the occupant an incentive to vacate the parking spot, such as a financial incentive. The incentive may include discounts to a current parking session's costs, discounts at nearby parking locations, discounts for future parking sessions, access to priority or reserved parking spots (e.g., spots closer to an elevator, establishment, or other amenity), and the like.

In determining what incentive to offer the occupant, the parking system 20 may consider historical data, user-inputted data (such as user-configured weighting, lists, options, etc.), and/or event-driven data. The parking system 20 may leverage computational models, algorithms, artificial intelligence models, machine learning models, neural network models, and the like to determine what incentives may be most effective for a given set of circumstances, and such models may be generalized to any occupants that park at a given location and/or may be personalized to a specific occupant. The parking system 20 may, additionally or alternatively, consider the demand for parking availability and adjust any incentives accordingly. For example, more or greater incentives may be offered when demand for parking availability is higher than would be offered when demand for parking availability is lower.

Depending on the nature of the response received by the parking system 20 from the occupant of the vehicle 10, the parking system 20 may, additionally or alternatively, send an occupant of a subsequent vehicle 11 an incentive, such as a financial incentive or the like as discussed above. Alternatively, the parking system 20 may include the incentive in the initial message. Such an incentive may be used to encourage the occupant of the subsequent vehicle 11 to park at a different parking location. Incentives such as this may be offered for a variety of reasons, such as to “compensate” the occupant of the subsequent vehicle 11 for the fact that a parking spot that was expected to be available will no longer be available, to balance demand and/or traffic in/around a parking facility, and the like.

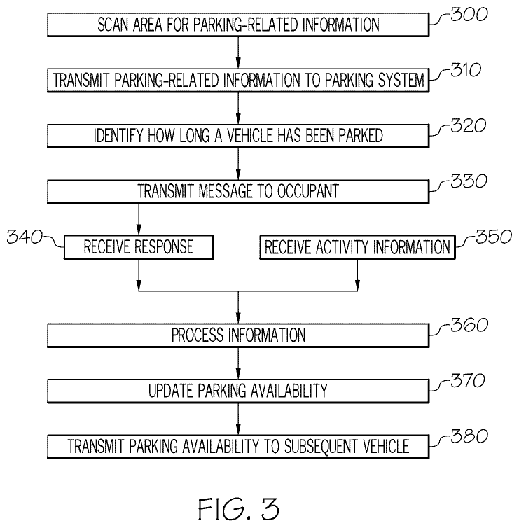

Turning now to FIG. 3, an exemplary process chart for managing parking information/availability is presented.

In step 300, one or more vehicles 10 may use sensors 12 to scan an area for parking-related information and/or parking availability. As discussed above, this information may include details as to the location of a given parking spot, the dimensions of a giving parking spot, whether the parking spot is occupied, signage relevant to the parking spot and/or corresponding rules, regulations, and/or impacts upon parking availability conferred by said signage, vehicle identifying information (e.g., a license plate, visible badging, wireless MAC address or similar, vehicle make, vehicle model, vehicle color, vehicle configuration, current state of the vehicle, and the like) relating to a parked vehicle, and so on. The vehicles 10 may also receive parking-related information and/or parking availability from infrastructure systems 30, or vice versa.

In a similar fashion to that discussed above for the one or more vehicles 10, the infrastructure system(s) may use sensors 32 to likewise collect parking-related information and/or parking availability.

In step 310, the parking-related information and/or parking availability may be communicated from the vehicles 10 and/or the infrastructure systems 30 to the parking system 20, either directly or indirectly. For example: the parking-related information and/or parking availability may be transmitted from an infrastructure system 30 to a vehicle 10, and then from the vehicle 10 to the parking system 20; the parking-related information and/or parking availability maybe transmitted from a vehicle 10 to an infrastructure system 30, and then from the infrastructure system 30 to the parking system 20; the parking-related information and/or parking availability may be transmitted from a vehicle 10 to the parking system 20; the parking-related information and/or parking availability may be transmitted from an infrastructure system 30 to the parking system 20; the parking-related information and/or parking availability may be transmitted from any of a vehicle 10 or infrastructure system 30 to a mobile device 40 and/or any other edge computing device or server, and then from the mobile device 40 and/or any other edge computing device to the parking system 20; without limitation.

In step 320, the parking system 20 may identify or otherwise determine how long a vehicle 10 has been parked in a given location. Additionally or alternatively, the parking system 20 may identify or otherwise determine whether a vehicle 10 has been parked in a given location for a predetermined amount of time, such as an amount of time for which an occupant paid to use the parking location (e.g., the occupant paid a parking meter for two hours of parking time), an average amount of time vehicles remain parked in a given location generally (e.g., “cars in grocery store parking lots remain parked for approximately forty minutes on average”), an average amount of time vehicles remain parked in a given location specifically as determined by historical data (e.g., on Tuesdays, cars in this spot/parking lot remain parked for approximately 30 minutes on average independent of however much time was paid for at a meter), and the like. This predetermined amount of time may further be adjusted based on activity of the occupant received by the parking system 20, such as from an establishment 70, point of sale system 72, or the like.

In step 330, the parking system 20 may transmit a message to an occupant of the vehicle 10, the message including an incentive for the occupant of the vehicle to remove the vehicle 10 from the parking location. As discussed above, the incentive may be a financial incentive, a priority incentive, a status incentive, or the like, without limitation. The message may be transmitted to the occupant's mobile device 40, directly or indirectly, to the vehicle 10, or to any relevant device for conveying the information therein to the occupant. The message and/or incentive may be any of a text message, an email, a push notification, a written message, an audio message, a graphical or video message, and the like, without limitation. The message may be conveyed immediately (such as by playing an audio message over speakers), or held in a queue, inbox, or the like until opened/played by the occupant.

In step 340, the occupant may respond to the message with a response that is received by the parking system 20. The response may take the form of an audio recording (e.g., the occupant says aloud “yes” or “no,” and this response is picked up by one or more microphones), written message, push message, signal, or the like. The occupant's response may be processed by the mobile device 40 or vehicle 10 before being sent to the parking system 20 in a more suitable format (e.g., software on board the vehicle identifies that the occupant said “yes,” and transmits a signal indicating acceptance rather than transmitting the audio recording), or the message may be transmitted as-is to the parking system 20 and processed thereby (e.g., the parking system 20 receives the audio recording and processes the audio to determine what was said).

The response may be a simple yes/no indication and/or may comprise further details. For example, the response may include information as to when the occupant plans to remove the vehicle 10 from the parking spot (e.g., “in 10 minutes,” “when the show is finished,” “once I finish shopping”). As another example, the response may include an occupant's selection of an incentive, such as when more than one incentive was offered in the vehicle's message or if the incentive was optional. As another example, the response may include any information necessary to carry out a transaction relating to the incentive. As another example, the response may include an attempt to modify an incentive (e.g., if the occupant was offered a $10 discount to remove the vehicle in the next 15 minutes, the occupant may offer to move the vehicle in the next 20 minutes for a reduced discount).

Additionally, the response may take the form of a lack of response from the occupant. The parking system 20 may still glean information from an occupant's failure to reply or choice not to reply to the message and derive predictions therefrom.

In combination with and/or independent of any response from the occupant, in step 350, an establishment 70, infrastructure system 30, or other device or service relating to activity of the occupant may transmit activity-related messaging to the parking system 20. For example, if the occupant swipes their credit card at a point of sale system 72, such as a grocery store checkout or a parking payment kiosk, the establishment 70, infrastructure system 30, and/or point of sale system 72 may transmit, directly or indirectly, messaging to the parking system 20 regarding these transactions or other related events. The activity-related messaging may occur automatically, independent of any specific action by the occupant directed to the same, or the activity-related messaging may only occur after the occupant has been specifically prompted whether they wish to notify the parking system 20 of their intent. The parking system 20 may then from this activity-related messaging infer that an occupant will remove their vehicle 10 from the parking location in a certain amount of time. For example, a parking infrastructure system 30 may give an occupant ten minutes to remove their vehicle from a parking garage once they have paid at the kiosk, and thus the parking system 20 may infer that the parking spot will be available in ten minutes. As another example, historical data may show that it takes occupants approximately twenty minutes on average to remove their vehicles from a parking spot after checking out at the grocery store, and so the parking system may infer that the spot will be available in twenty minutes.

In step 360, the parking system 20 may process the response, lack thereof, and/or activity-related messaging, carrying out any functions, transmissions, or the like necessary to actualize the same.

In step 370, the parking system 20 may update the availability of the parking location based on the occupant's response, lack thereof, and/or activity-related messaging from the establishment 70, point of sale system 72, or infrastructure system. For example, if the occupant has not replied to the message, the parking system 20 may presume a negative response and/or revert to other means for determining parking availability, such as by retrieving average parking times or the like to better estimate when the parking location will become available. As another example, if the occupant has replied positively to the message, the parking system 20 may update the availability of the parking location accordingly (e.g., if the occupant accepted an incentive to move the vehicle within the next ten minutes, the parking system may flag the parking location as available or as tentatively available to those subsequent vehicles 11 which are more than ten minutes away).

The parking system's 20 marking/flagging of a parking location as being available may further take into account margins of error, margins of safety, margins based on historical data, rule-based margins, or the like. For example, it may be the case that, historically, following the end of a film, it takes moviegoers approximately fifteen minutes to leave their parking spots. Accordingly, the parking system 20 may flag a given spot available fifteen minutes after a film is scheduled to end instead of precisely when the film ends. As another example, the parking system 20 may apply a margin to the prediction as to parking availability simply as a general rule, such as five, ten, or twenty minutes after a certain time that the parking space should become available (e.g., even though a parking meter 36 will run out in ten minutes and the occupant should have removed the vehicle 10 by then, the parking system 20 may instead flag the parking location as available twenty minutes from now instead of ten minutes).

In step 380, the parking system 20 may communicate to a subsequent vehicle 11 parking availability information which has been updated further to the above. This parking availability information may take into account the time remaining for the subsequent vehicle 11 to arrive in the area. For example, parking information transmitted to a subsequent vehicle 11 currently in the area may differ from the parking information transmitted to a subsequent vehicle 11 that is fifteen minutes away, which may further differ from parking information transmitted to a subsequent vehicle 11 that is forty minutes away.

The parking availability information communicated to subsequent vehicles 11 may vary in resolution. For example, the parking system 20 may provide spot-by-spot information to a subsequent vehicle 11; the parking system 20 may provide parking availability on a lot-by-lot, garage-by-garage, street-by-street, or similar basis to the subsequent vehicle 11; the parking system 20 may provide parking availability on a block-by-block basis or other comparable, larger/smaller unit area which may consolidate different types of parking (e.g., a given unit area may include two parking garages, an open air lot, and on-street parking which may be served by different parking authorities/owners) or which may be grouped by parking type (e.g., one unit area may consolidate on-street parking for multiple streets, another unit area may consolidate multiple parking garages, another unit area may consolidate multiple open-air parking lots, and the like).

The parking availability information communicated to subsequent vehicles 11 may take the form of a heat map representing the probabilities of parking being available in given location when the subsequent vehicle 11 arrives.

The manner in which or resolution at which this parking availability is communicated to subsequent vehicles 11 may optionally depend on how far away the subsequent vehicle 11 is from the area. For example, subsequent vehicles 11 which are further away or further out may be provided parking availability on a larger unit basis, due in part to the greater uncertainty that may be associated with spot-by-spot availability over the relevant time frames, whereas subsequent vehicles 11 which are currently in the area may be provided parking availability on a spot-by-spot basis.

The frequency at which parking availability information is received or queried for may also depend on how far away the subsequent vehicle 11 is from the area. For example, a subsequent vehicle 11 which is currently in the area may receive parking availability updates from the parking system 20 in real-time or with minimal delay, whereas a subsequent vehicle 11 which is further away may only receive parking availability updates every so often, such as once every minute, two minutes, five minutes, ten minutes, and/or the like.

The parking availability information provided to subsequent vehicles 11 may then be used as part of route guidance, navigation, or the like. For example, after identifying a parking location, guidance and/or navigation of the vehicle 10 may direct the occupant to drive towards the parking location so identified.

As another example, parking availability information may be provided on a probability basis based on possible navigation options which may be taken by an occupant. For instance, the vehicle may communicate to the occupant (such as via audio instructions, visual displays, or the like) that turning right at an upcoming intersection will result in an eighty-percent likelihood of finding a parking space, whereas turning left at the upcoming intersection will result in only a ten-percent likelihood of finding a parking space. Accordingly, even in those situations where uncertainty regarding specific, spot-by-spot parking availability is high, occupants of subsequent vehicles 11 currently in an area looking for parking may yet be given useful information to assist in more quickly finding appropriate parking.

All of the forms of parking availability information discussed above may optionally be filtered based on an occupant's preference, user profiles 60, or vehicle type. For example, if the occupant is in a larger vehicle which may have difficulty using on-street parking, on-street parking may be filtered from the parking availability information provided to the subsequent vehicle 11.

Additionally, when communicating parking availability information to the subsequent vehicle 11, the parking system 20 may include an incentive for the subsequent vehicle 11 to park in a different location or a different area. The incentive provided to the subsequent vehicle 11 may be adjusted based on how much further from a destination the different location/area is from an originally chosen location/area, whether the different location/area comports with the user profile 60 of an occupant of the subsequent vehicle 11, and the like.

It should now be understood that embodiments of the present disclosure are directed to systems and methods networked parking solutions.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A system for managing parking availability, comprising:
a parking system including at least one processor,
wherein the parking system is configured to:
identify whether a vehicle has been parked at a parking location for a predetermined amount of time,
transmit a message to an occupant of the vehicle, the message including an incentive for the occupant of the vehicle to remove the vehicle from the parking location, and
receive, from the occupant, a response to the message, the response including an indication as to whether the occupant will remove the vehicle from the parking location, and
transmit, to a second vehicle and prior to removal of the vehicle from the parking location, information regarding parking availability at the parking location derived from the indication as to whether the occupant will remove the vehicle from the parking location.

2. (canceled)

3. The system according to claim 1, wherein the predetermined amount of time is an amount of time for which the occupant paid to use the parking location.

4. The system according to claim 1, wherein the predetermined amount of time is an average amount of time vehicles remain parked at the parking location.

5. The system according to claim 4, wherein the average amount of time is based on historical parking data stored by the parking system.

6. The system according to claim 1, wherein the incentive is a financial incentive.

7. The system according to claim 1, wherein the incentive encourages the occupant to park the vehicle at a different location.

8. The system according to claim 1, wherein the predetermined amount of time is adjustable in response to a processing of a transaction relating to the occupant at a point of sale system.

9. The system according to claim 1, wherein the parking system is an Internet-accessible computing system.

10. The system according to claim 1, wherein, after receiving the response, the system is further configured to transmit, to a second vehicle, information regarding parking availability for a different location and an incentive to park at the different location.

11. A method for managing parking availability, comprising the steps of:
identifying whether a vehicle has been parked at a parking location for a predetermined amount of time,
transmitting a message to an occupant of the vehicle, the message including an incentive for the occupant of the vehicle to remove the vehicle from the parking location,
receiving, from the occupant, a response to the message, the response including an indication as to whether the occupant will remove the vehicle from the parking location, and
transmitting, to a second vehicle and prior to removal of the vehicle from the parking location, information regarding parking availability at the parking location derived from the indication as to when the occupant will vacate the parking location.

12. The method according to claim 11, wherein the predetermined amount of time is an average amount of time vehicles remain parked at the parking location.

13. The method according to claim 12, wherein the average amount of time is based on historical parking data stored by a parking system.

14. The method according to claim 11, wherein the predetermined amount of time is adjustable in response to a processing of a transaction relating to the occupant at a point of sale system.

15. The method according to claim 11, wherein the steps of identifying, transmitting, and receiving are performed by a parking system which receives, from one or more sensors provided on at least one of the vehicle, an infrastructure system, and another vehicle, sensor data relating to parking availability in an area.

16.-20. (canceled)

21. The system according to claim 1, wherein the parking system is configured to receive data from at least one sensor for identifying whether the vehicle has been parked at the parking location for the predetermined amount of time.

22. The system according to claim 21, wherein the at least one sensor comprises a camera.

23. The system according to claim 21, wherein the at least one sensor is a vehicle-mounted sensor.

24. The system according to claim 23, wherein the vehicle-mounted sensor is provided on a vehicle separate from the vehicle and the second vehicle.
